(19) United States
(12) Patent Application Publication
(10) Pub. No.: US 2011/0032998 A1
(43) Pub. Date: Feb. 10, 2011

(54) METHOD FOR CONTROLLING BLACK LEVEL OF INPUT SIGNAL AND VIDEO APPARATUS USING THE SAME

(76) Inventor: Sung Jin Park, Gumi-si (KR)

Correspondence Address: KED & ASSOCIATES, LLP, P.O. Box 8638, Reston, VA, 20195, US

(21) Appl. No.: 12/988,916

(22) PCT Filed: Apr. 21, 2009
(86) PCT No.: PCT/KR09/02076

§ 371 Date: Oct. 21, 2010

(30) Foreign Application Priority Data
Apr. 22, 2008 (KR) 10-2008-0037342

(51) Int. Cl. H04N 7/26

(52) U.S. Cl. 375/240.25; 375/E07.027

(57) ABSTRACT

A method for controlling the black level of an input signal and a video apparatus using the same are disclosed. The video apparatus includes a histogram analysis module (701) for decoding a video signal of each frame input to the video apparatus to a luminance signal and analyzing a histogram of the decoded luminance signal, a black level detection module (702) for determining a type of the video signal according to a result of the histogram analysis, and a black adjustment module (703) for adjusting a black level of the video signal according to the type of the video signal.

### TECHNICAL FIELD

The present invention relates to a method for adjusting a black level in a video apparatus and a video apparatus using the same, and more particularly, to a method for improving video quality in a video apparatus by decoding a video signal of each frame input to the video apparatus to a luminance signal, analyzing the histogram of the decoded luminance signal, and accurately setting a black level for the video signal according to the result of the histogram analysis, and a video apparatus using the same.

### BACKGROUND ART

In view of the variety of the types of external devices that transmit video signals to a video apparatus, the video signals are also various.

Among video signals input to the video apparatus, especially a Composite Video Blanking Sync (CVBS) signal or a High Definition Multimedia Interface (HDMI) signal includes a plurality of types of signals. Therefore, a black level should be adjusted differently for different signal types. A conventional video apparatus has limitations in accurately identifying the type of an input signal and thus a user should set a black level manually.

For example, the conventional video apparatus provides an additional user interface so that the user chooses one of high or low as the black level through the user interface.

However, in the case of the manual black level setting of a video signal input to the video apparatus, the user may adjust the black level without accurate knowledge of the type of an input signal. The resulting black and white saturation or the like brings about the degradation of video quality.

Even though the video apparatus receives information indicating the type of a video signal from an external device, transmission and reception of the type information are failed in many cases. As a consequence, errors occur due to wrong black level adjustment.

In this context, there exists a pressing need for developing a video apparatus for accurately identifying the type of a signal received from an external device at a video apparatus by analyzing the histogram of the received signal and adjusting the black level of the input signal according to its type in order to avoid the video quality degradation caused by black and white saturation and improve the output quality of the video signal.

### DISCLOSURE OF INVENTION

### Technical Problem

An object of the present invention devised to solve the problem lies on a method for analyzing the luminance histogram of an input video signal and adjusting the black level of the video signal according to the histogram analysis in order to improve video quality in a video apparatus, and a video apparatus using the same.

### Technical Solution

The object of the present invention can be achieved by providing a video apparatus including a histogram analysis module for decoding a video signal of each frame input to the video apparatus to a luminance signal and analyzing a histogram of the decoded luminance signal, a black level detection module for determining a type of the video signal according to a result of the histogram analysis, and a black adjustment module for adjusting a black level of the video signal according to the type of the video signal.

In another aspect of the present invention, provided herein is a black level adjustment method including decoding a video signal of each frame input to a video apparatus to a luminance signal and analyzing a histogram of the decoded luminance signal, determining a type of the video signal according to a result of the histogram analysis, and adjusting a black level of the video signal according to the type of the video signal.

### Advantageous Effects

The type of a video signal input to a video apparatus is identified by analyzing the histogram of the video signal and the black level of the video signal is adjusted according to the signal type. The accurate adjustment of the black level of the video signal enables output of the video signal without quality degradation such as black and white saturation or the like.

### BRIEF DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a flowchart illustrating an operation for adjusting the black level of a video signal input to a video apparatus according to an exemplary embodiment of the present invention.

FIG. 2 illustrates an analysis of the histogram of the luminance signal of a video signal on a frame-by-frame basis according to an exemplary embodiment of the present invention.

FIG. 3 illustrates an analysis of the histogram of the luminance signal of a predetermined region in a video signal of each frame according to an exemplary embodiment of the present invention.

FIG. 4 illustrates a histogram analysis that is performed by counting the number of pixels included in a predetermined section in a video apparatus according to an exemplary embodiment of the present invention.

FIG. 5 illustrates identification of video signals as first signals and second signals according to histogram analysis results according to an exemplary embodiment of the present invention.

FIG. 6 is a graph illustrating adjustment of the black level of a video signal according to an exemplary embodiment of the present invention.

FIG. 7 is a block diagram of a video apparatus according to an exemplary embodiment of the present invention.

### BEST MODE FOR CARRYING OUT THE INVENTION

Reference will now be made in detail to the preferred embodiments of the present invention, examples of which are illustrated in the accompanying drawings.

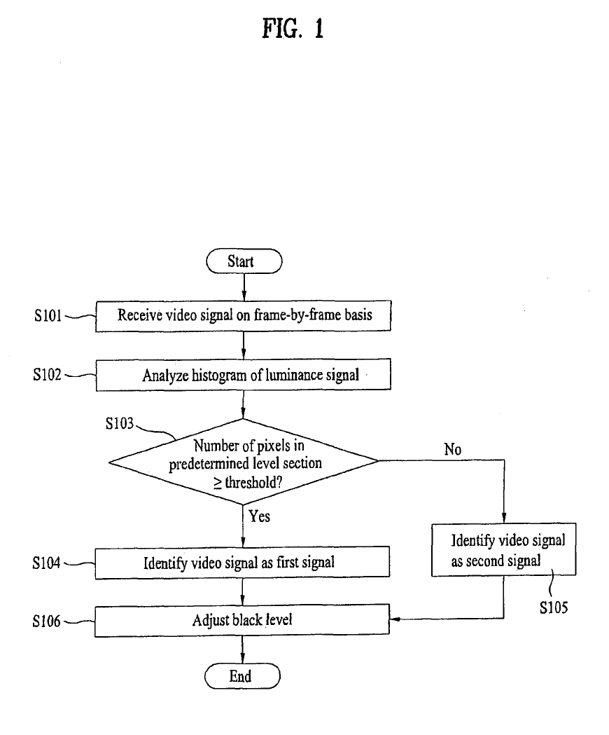

FIG. 1 is a flowchart illustrating an operation for adjusting the black level of a video signal input to a video apparatus according to an exemplary embodiment of the present invention.

Referring to FIG. 1, the video apparatus decodes the luminance signal of an input video signal of each frame in step S101 and analyzes the histogram of the decoded luminance signal in step S102.

The histogram analysis may be carried out by measuring the luminance levels of the pixels of the frame and then counting the number of pixels included in each luminance level section.

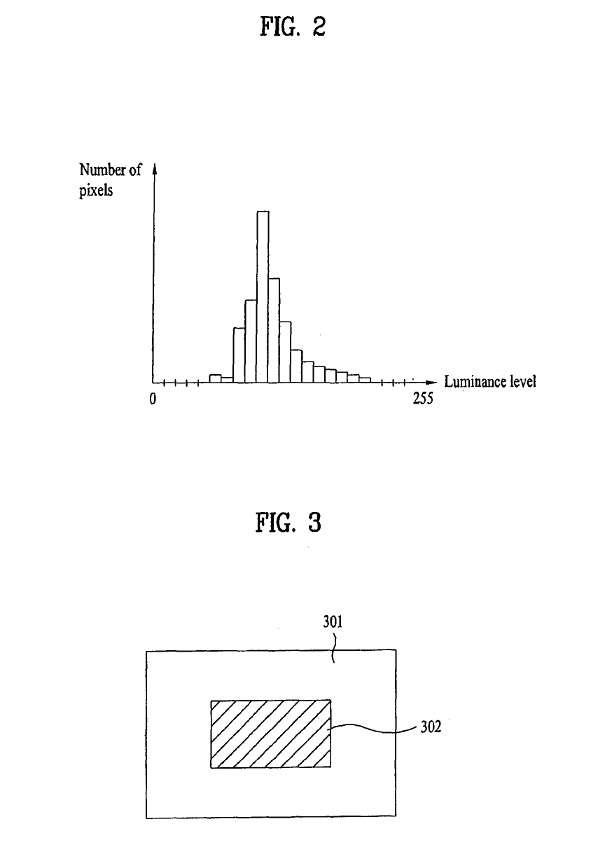

FIG. 2 illustrates an analysis of the histogram of the luminance signal of a video signal on a frame-by-frame basis according to an exemplary embodiment of the present invention.

Referring to FIG. 2, the video apparatus may divide the levels of the decoded luminance signal into a predetermined number of luminance level sections and count the number of pixels included in each luminance level section.

For example, the video apparatus may define level sections 0 to 255 for the luminance signal and count the number of pixels included in each level section.

The luminance level sections may be defined in various manners according to exemplary embodiments of the present invention. For instance, the level sections 0 to 255 may be divided into bins 0 to 32 so that the video apparatus may count the number of pixels included in each bin.

The video apparatus may confine the histogram analysis to a predetermined region of the frame of the video signal in order to reduce the volume of computation taken for the histogram analysis in an exemplary embodiment of the present invention.

FIG. 3 illustrates an analysis of the histogram of the luminance signal of a predetermined region in a video signal of each frame according to an exemplary embodiment of the present invention.

Referring to FIG. 3, the video apparatus analyzes only the histogram of pixels included in a predetermined region 302 of an entire frame 301, to thereby reduce computation.

In step S103, the video apparatus counts the number of pixels included in a predetermined luminance level section. The video apparatus may further determine whether the number of pixels included in the predetermined luminance level section is equal to or larger than a threshold.

The predetermined luminance level section may vary with the type of a video signal to be identified.

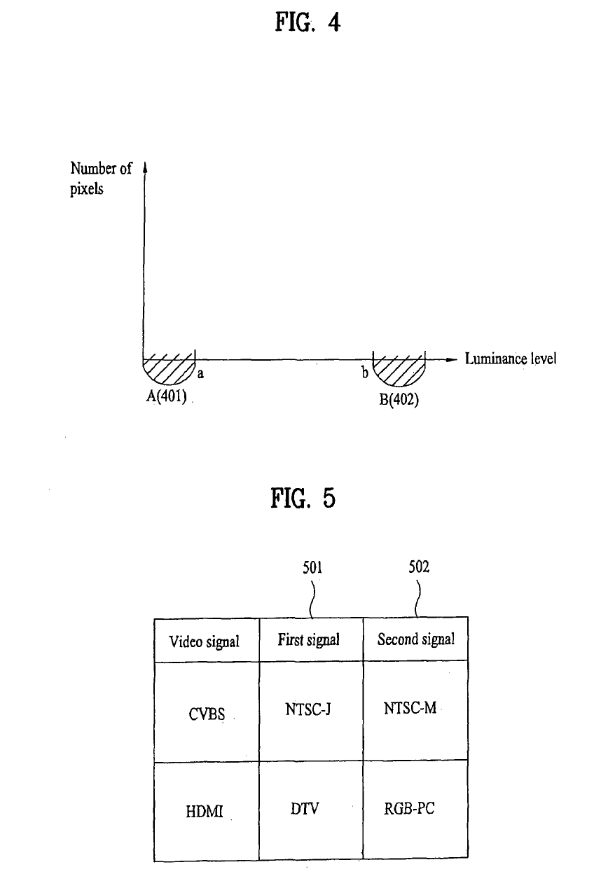

FIG. 4 illustrates a histogram analysis that is performed by counting the number of pixels included in a predetermined section in a video apparatus according to an exemplary embodiment of the present invention.

Referring to FIG. 4, the video apparatus may perform a histogram analysis by counting the numbers of pixels included in predetermined sections A and B 401 and 402 among a predetermined number of level sections. That is, the video apparatus may count the number of pixels with luminance levels 401 equal to or lower than a first level a and the number of pixels with luminance levels 402 equal to or higher than a second level b. The predetermined level sections may vary in their ranges according to the type of a video signal to be identified.

The threshold may vary in exemplary embodiments of the present invention. A small threshold narrows an error range and thus enables more accurate identification of a signal type. On the other hand, when noise occurs, the small threshold may cause errors because a wrong signal type is identified.

For example, the video apparatus may count the number of pixels included in a first level section 0 to 16 and the number of pixels included in a second level section 235 to 255 and compares the numbers with a threshold of 5.

If the number of pixels included in the predetermined section is equal to or larger than the threshold in step S103, the video apparatus identifies the video signal as a first signal in step S104. If the number of pixels included in the predetermined section is smaller than the threshold in step S103, the video apparatus identifies the video signal as a second signal in step S104.

For example, the video apparatus may count the number of pixels included in the first level section 0 to 16 and the number of pixels included in the second level section 235 to 255. If the sum of the counts is equal to or larger than 5, the video signal may be identified as a first signal and if the sum of the counts is smaller than 5, the video signal may be identified as a second signal.

FIG. 5 illustrates identification of video signals as first signals and second signals according to histogram analysis results according to an exemplary embodiment of the present invention.

Referring to FIG. 5, when it receives a CVBS signal, the video apparatus may identify the CVBS signal as a first signal, Japan National Television System Committee (NTSC-J) or as a second signal, Mexico NTSC (NTSC-M) according to the foregoing histogram analysis.

When it receives an HDMI signal, the video apparatus may identify the HDMI signal as a first signal, Digital TV (DTV) or as a second signal, Red, Green, Blue-Personal Computer (RGB-PC) according to the histogram analysis.

The results of the signal type identification according to an exemplary embodiment of the present invention are illustrated in FIG. 5 and the video apparatus may identify various types of signals through a variety of histogram analyses.

Referring to FIG. 1 again, the video apparatus identifies the type of the video signal according to the result of the histogram analysis and adjusts the black level of the video signal according to the identified signal type in step S106.

For example, if the video apparatus identifies the video signal as the first signal, it adjusts the gain and offset value of the video signal so that the luminance signal of the video signal has a luminance level between 16 and 235. If the video apparatus identifies the video signal as the second signal, it just lets the video signal bypass without adjusting the black level of the video signal.

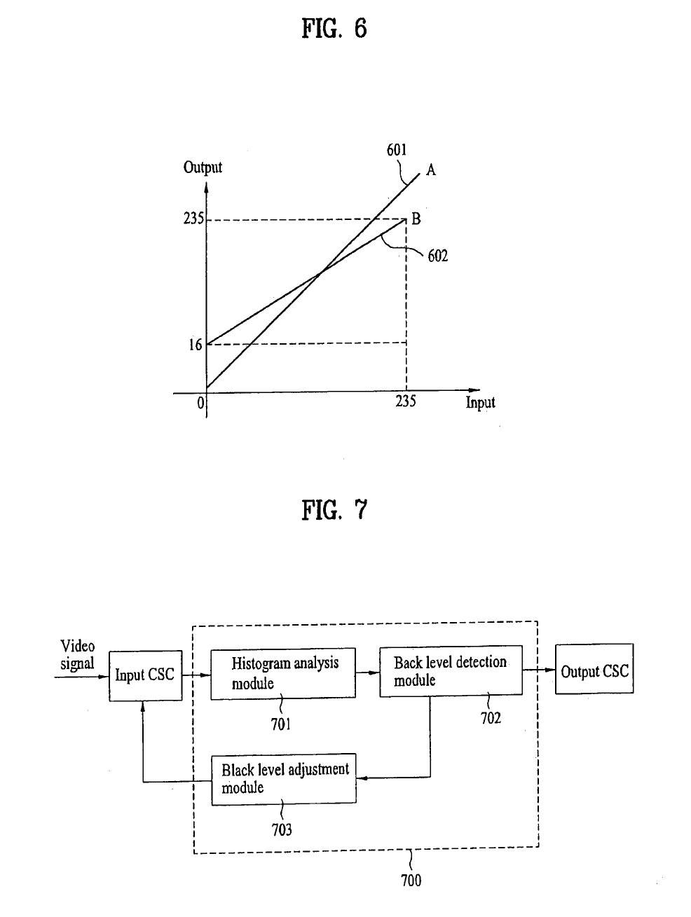

FIG. 6 is a graph illustrating adjustment of the black level of a video signal according to an exemplary embodiment of the present invention.

Referring to FIG. 6, when the video apparatus identifies an input video signal as a first signal 601 according to a histogram analysis, it may adjust the black level of the video signal as indicated by reference numeral 602 by adjusting the gain and offset value of the video signal.

Since the video apparatus identifies the type of a video signal received from an external device by analyzing the histogram of the video signal and adjusts the black level of the video signal according to the signal type, it applies an accurate black level to the video signal. Therefore, the video signal is output without degradation of video quality such as black and white saturation or the like.

In the mean time, it is not necessary to perform a histogram analysis on all frames of an input video signal. Hence, the video apparatus may sample a predetermined number of frames of the input video signal, analyze the histograms of the frames, and adjust the black levels of the frames according to the histogram analysis in an exemplary embodiment of the present invention. As a result, computation is reduced and a signal type is fast identified in black level adjustment.

Also, the type of an input video signal needs to be identified each time the external device changes. In accordance with an exemplary embodiment of the present invention, the operation described in FIG. 1 may be performed whenever the external device that transmits a video signal to the video apparatus is changed.

FIG. 7 is a block diagram of a video apparatus according to an exemplary embodiment of the present invention. In the exemplary embodiment of the present invention, the video apparatus includes a histogram analysis module 701, a black level detection module 702, and a black level adjustment module 703.

The histogram analysis module 701 decodes the luminance signal of a video signal of each frame input to the video apparatus and analyses the histogram of the decoded luminance signal. An exemplary embodiment of the histogram analysis has been described before with reference to FIG. 2.

The histogram analysis module 701 may perform the histogram analysis by dividing the histogram of the luminance signal into a predetermined number of sections and counting the number of pixels included in a predetermined section among the predetermined number of sections.

For example, the histogram analysis module 701 counts the number of pixels at levels equal to or lower than a first level, level 16 and the number of pixels at levels equal to or higher than a second level, level 255. If the sum of the counts is equal to or larger than a predetermined number, the histogram analysis module 701 identifies the video signal as a first signal. If the sum of the counts is smaller than the predetermined number, the histogram analysis module 701 identifies the video signal as a second signal.

The histogram analysis module 701 may also decode the video signal of each of a predetermined number of frames input to the video apparatus to a luminance signal and analyze the histogram of the decoded luminance signal, to thereby reduce the computation volume taken for black level adjustment.

Also, the histogram analysis module 701 may decode the video signal of a predetermined region of each frame input to the video apparatus to a luminance signal and analyze the histogram of the decoded luminance signal, to thereby reduce the computation volume taken for black level adjustment.

Each time the external device that transmits a video signal to the video apparatus changes, the histogram analysis module 701 may decode a video signal to a luminance signal and analyze the histogram of the luminance signal.

The black level detection module 702 determines the type of the video signal according to the result of the histogram analysis.

The black level adjustment module 703 adjusts the black level of the video signal according to the type of the video signal.

For adjusting the black level of the video signal, the black level adjustment module 703 may apply a different gain and offset value for a different signal type.

The video apparatus according to the exemplary embodiment of the present invention has been described above and the afore-described same operations are applied to the video apparatus illustrated in FIG. 7. Thus, a detailed description of the operations will not be provided redundantly herein.

### MODE FOR THE INVENTION

Various embodiments have been described in the best mode for carrying out the invention.

### INDUSTRIAL APPLICABILITY

According to the present invention, an accurate black level is applied to a video signal received from an external device. Therefore, the video signal is output without the degradation of video quality such as black and white saturation or the like.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A video apparatus comprising:
a histogram analysis module for decoding a video signal of each frame input to the video apparatus to a luminance signal and analyzing a histogram of the decoded luminance signal;
a black level detection module for determining a type of the video signal according to a result of the histogram analysis; and
a black adjustment module for adjusting a black level of the video signal according to the type of the video signal.

2. The video apparatus according to claim 1, wherein the histogram analysis module performs the histogram analysis by dividing the histogram into a predetermined number of sections and counting the number of pixels included in a predetermined section among the divided segments.

3. The video apparatus according to claim 2, wherein the histogram analysis module counts the number of pixels in a section of a first level or lower or the number of pixels in a section of a second level or higher, determines the video signal to be a first signal, if the number is equal to or larger than a threshold, and determines the video signal to be a second signal, if the number is smaller than the threshold.

4. The video apparatus according to claim 1, wherein the black level adjustment module adjusts the black level of the video signal by applying a different gain or offset value to the video signal according to the type of the video signal.

5. The video apparatus according to claim 1, wherein the histogram analysis module decodes video signals of a predetermined number of frames input to the video apparatus to luminance signals and analyzes histograms of the decoded luminance signals.

6. The video apparatus according to claim 1, wherein the histogram analysis module decodes a video signal of a predetermined region within the video signal of the frame and analyzes a histogram of the video signal of the predetermined region.

7. The video apparatus according to claim 1, wherein each time an external apparatus for transmitting the video signal to the video apparatus is changed, the histogram analysis module decodes a video signal of each frame to a luminance signal and analyzes a histogram of the decoded luminance signal.

8. A black level adjustment method comprising:
decoding a video signal of each frame input to a video apparatus to a luminance signal and analyzing a histogram of the decoded luminance signal;
determining a type of the video signal according to a result of the histogram analysis; and
adjusting a black level of the video signal according to the type of the video signal.

9. The black level adjustment method according to claim 8, wherein the histogram analysis comprises performing the histogram analysis by dividing the histogram into a predetermined number of sections and counting the number of pixels included in a predetermined section among the divided sections.

10. The black level adjustment method according to claim 9, wherein the histogram analysis comprises counting the number of pixels in a section of a first level or lower or the number of pixels in a section of a second level or higher, determining the video signal to be a first signal, if the number is equal to or larger than a threshold, and determining the video signal to be a second signal, if the number is smaller than the threshold.

11. The black level adjustment method according to claim 8, wherein the black level adjustment comprises adjusting the black level of the video signal by applying a different gain or offset value to the video signal according to the type of the video signal.

12. The black level adjustment method according to claim 8, wherein the histogram analysis comprises decoding video signals of a predetermined number of frames input to the video apparatus to luminance signals and analyzing histograms of the decoded luminance signals.

13. The black level adjustment method according to claim 8, wherein the histogram analysis comprises decoding a video signal of a predetermined region within the video signal of the frame and analyzing a histogram of the video signal of the predetermined region.

14. The black level adjustment method according to claim 8, wherein each time an external apparatus for transmitting the video signal to the video apparatus is changed, the histogram analysis comprises decoding a video signal of each frame to a luminance signal and analyzing a histogram of the decoded luminance signal.
